(19) United States
(12) Patent Application Publication
(10) Pub. No.: US 2008/0083086 A1
(43) Pub. Date: Apr. 10, 2008

(54) Glass door hinge structure

(75) Inventor: Ching-Yi Lin, Changhua Hsien (TW)

Correspondence Address: RABIN & Berdo, PC, 1101 14TH STREET, NW, SUITE 500, WASHINGTON, DC, 20005, US

(73) Assignee: Lin Kun Ta Industrial Co., Ltd., Changhua Hsien (TW)

(21) Appl. No.: 11/543,846

(22) Filed: Oct. 6, 2006

(51) Int. Cl. E05D 5/02

(52) U.S. Cl. 16/252

(57) ABSTRACT

A glass door hinge structure is installed on a lateral side of a glass door, and the glass door is combined with a hinge body, a hinge cover, an axial bolt and a fixing base, and the fixing base is fixed on the edge of a doorway. The hinge body is a thickened face portion, and the hinge cover has a protrusion attached onto an internal surface of the hinge cover, and the protrusion is in form of an indent, and both sides of the indent separately have a penetrating hole for installing the axial bolt, and the upper and lower positions of the thickened face portion have two transversally disposed screw thread holes and penetrated through the inner edge of the penetrating hole for an interconnection. A right-angled concavely cut plane is disposed on both upper and lower positions on the same side of the axial bolt, such that when the axial bolt is passed through the hinge body and the fixing base and the long screw bolt outside the hinge body is screwed into the screw thread hole and to a limit position on the concavely cut plane of the axial bolt of the penetrating hole. Finally, the glass door and hinge cover are installed, and the long screw bolt is turned to adjust the angle of the glass door and align the glass door evenly with the doorway. The invention also can enhance the screw connection and use of the long screw bolt and prevent it from being damaged easily.

### BACKGROUND OF THE INVENTION

1. Field of the Invention

The present invention relates to a glass door hinge structure, and more particularly to a glass door hinge structure installed at upper and lower positions on a lateral side of a glass door, such that after the glass door is combined with a hinge body, a hinge cover, an axial bolt and a fixing base, and the fixing base is fixed on an edge of the doorway, a long screw bolt can be turned to adjust the glass door to an angle to align the glass door evenly with a doorway, and the invention can prevent damages by adopting a screw connection and an enhanced long screw bolt.

2. Description of the Related Art

Referring to FIGS. 1A and 1B for a general traditional glass door hinge structure, the structure includes a hinge body A, a hinge cover B, an axial bolt C and a fixing base D. A protrusion A1 is disposed on the hinge body A and attached to an internal surface of the hinge cover B, and the protrusion A1 has an indent A2, and both sides of the indent A2 respectively have a penetrating hole A3 for installing the axial bolt C, and a distal surface outside the penetrating hole A3 has two screw thread holes A4 disposed transversally and parallel to each other, such that the screw thread holes A4 are penetrated through an inner edge of the penetrating hole A3. A through hole B1 is formed on the surface of the hinge cover B for passing and screwing a screw bolt E into the screw thread hole A4 of the protrusion A1 of the hinge body A, and a concavely cut plane C1 in an oblique form is disposed separately at upper and lower positions on the same side of the axial bolt C, and a through hole D2 in a vertical form is disposed on the protrusion D1 protruded from the fixing base D, such that after the indent A2 on the hinge body A is embedded with the protrusion D1 in the fixing base D to align the through hole D2 of the protrusion D1 of the fixing base D precisely with two penetrating holes A3 on the protrusion A1 of the hinge body A. After the axial bolt C passes through the penetrating hole A3 and the through hole D2 for the installation of combining the glass door F and the hinge cover B, the screw bolt E outside the hinge cover B can be screwed into the through hole B1 and the screw thread hole A4 of the hinge body A, such that the axial bolt C in the penetrating hole A3 contacts and presses against the concavely cut plane C1 as shown in FIG. 2B. After the glass door F is installed at a position between the hinge body A and the hinge cover B and the fixing base D is fixed onto an edge of the doorway as shown in FIG. 2A, the installed glass door F does not always align evenly with the doorway, and sometimes the glass door F may have a small angle deviated slightly inward or outward from the doorway. Thus, the screw bolt E can be turned inward or outward to rotate the axial bolt C with an angle to drive the glass door F, the hinge body A and the hinge cover B to turn slightly, so as to align the glass door F evenly with the doorway.

However, experienced construction workers at construction sites usually find that if the angle of the foregoing glass door F is adjusted, the screw bolt E is screwed into the screw thread hole A4 adjacent to the penetrating hole A3 in the indent A2 of the hinge body A, and the length of the thread in the screw thread hole A4 is too short, and thus only a very short length is available for the screw connection. If a construction work is not completed at one time, repeated installations for several times will completely damage the screw thread hole A4, and the angle adjustment cannot be made for the next time. As a result, a rework is needed, and such time-consuming and laborious construction causes tremendous inconvenience.

### SUMMARY OF THE INVENTION

In view of the foregoing shortcomings of the present invention, the inventor of the present invention based on years of experience on the related field to conduct extensive experiments and modifications and finally developed a glass door hinge structure in accordance with the present invention.

Therefore, it is a primary objective of the present invention to overcome the shortcomings of the prior art by providing a glass door hinge structure that can be installed on a lateral side of a glass door after the glass door is combined with the hinge body, hinge cover, axial bolt and fixing base, and the fixing base is fixed on the edge of a doorway. The hinge body is a thickened face portion, and the hinge cover has a protrusion attached onto an internal surface of the hinge cover, and the protrusion is in form of an indent, and both sides of the indent respectively have a penetrating hole for installing the axial bolt, and upper and lower positions of the thickened face portion have two transversal screw thread holes, such that the screw thread hole can be penetrated through the inner edge of the penetrating hole for an interconnection. A right-angled concavely cut plane is disposed on upper and lower positions on the same side of the axial bolt, so that after the indent on the hinge body is embedded with the protrusion in the fixing base, the through hole of the protrusion in the fixing base can be aligned precisely with two penetrating holes of the protrusion of the hinge body and a passing hole of the axial bolt, and the long screw bolt outside the hinge body can be screwed into the screw thread hole all the way to the upper limit position of the axial bolt concavely cut plane of the penetrating hole. Finally, the glass door and hinge cover are installed, and the long screw bolt is turned to adjust the angle of the glass door and align the glass door evenly with the doorway. The invention also can enhance the screw connection and application of the long screw bolt and prevent the glass door hinge structure from being damaged easily.

Another objective of the present invention is to provide a glass door hinge structure, wherein a right-angled concavely cut plane is disposed at upper and lower positions of the same side of the axial bolt and embedded into the fixing base of the hinge body. After the axial bolt is passed through the two holes, the long screw bolt outside the hinge body is screwed into its screw thread hole and onto the concavely cut plane of the of the penetrating hole of the axial bolt, and the whole distal surface of the long screw bolt can be attached completely onto the concavely cut plane of the axial bolt. The long screw bolt is turned inward or outward for adjusting the angle of the glass door and evenly aligning the glass door with the doorway.

### BRIEF DESCRIPTION OF THE DRAWINGS

FIG. 1A is an exploded view of a prior art;

FIG. 1B is a perspective view of an assembly of a prior art;

FIG. 2A is a schematic view of an installing position of a prior art;

FIG. 2B is a schematic view of an installed structure of a prior art;

FIG. 3A is an exploded view of a structure of the present invention;

FIG. 3B is another exploded view of a structure of the present invention;

FIG. 4A is a perspective view of an assembly of the present invention;

FIG. 4B is another perspective view of an assembly of the present invention;

FIG. 5 is a schematic view of an installing position of the present invention; and

FIG. 6 is a schematic view of an assembly of the present invention.

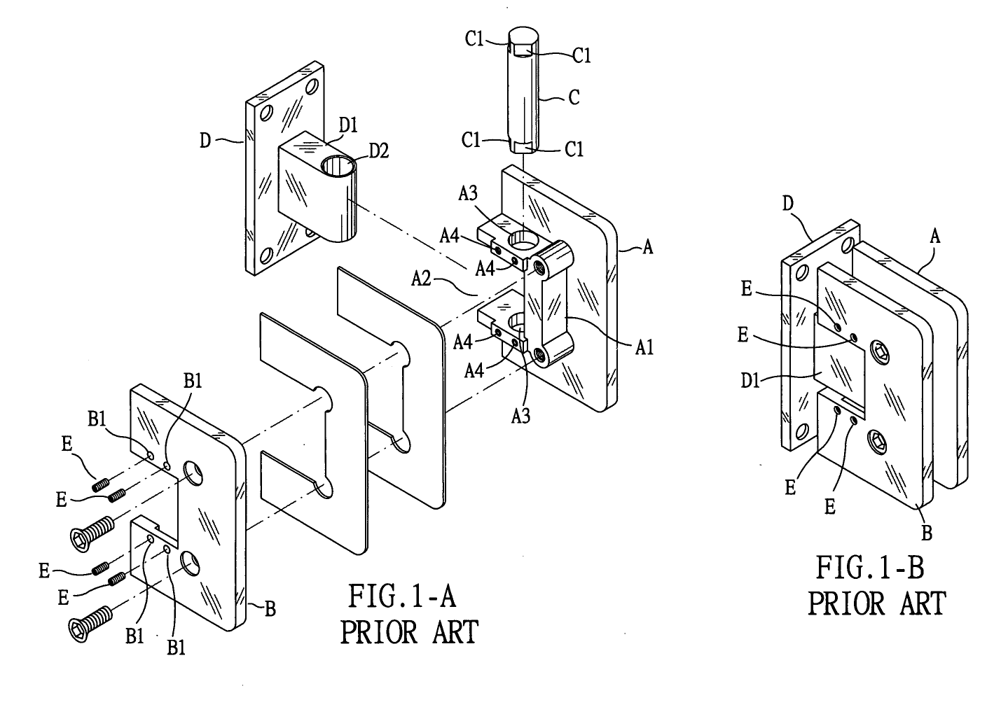

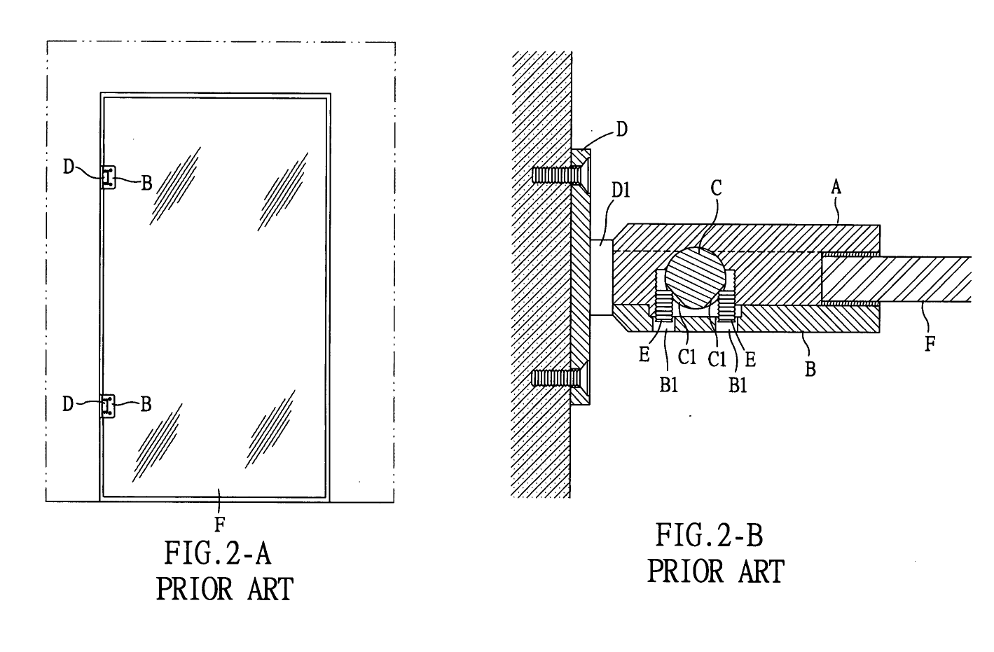

### DETAILED DESCRIPTION OF THE PREFERRED EMBODIMENTS

The above and other objects, features and advantages of the present invention will become apparent from the following detailed description taken with the accompanying drawing.

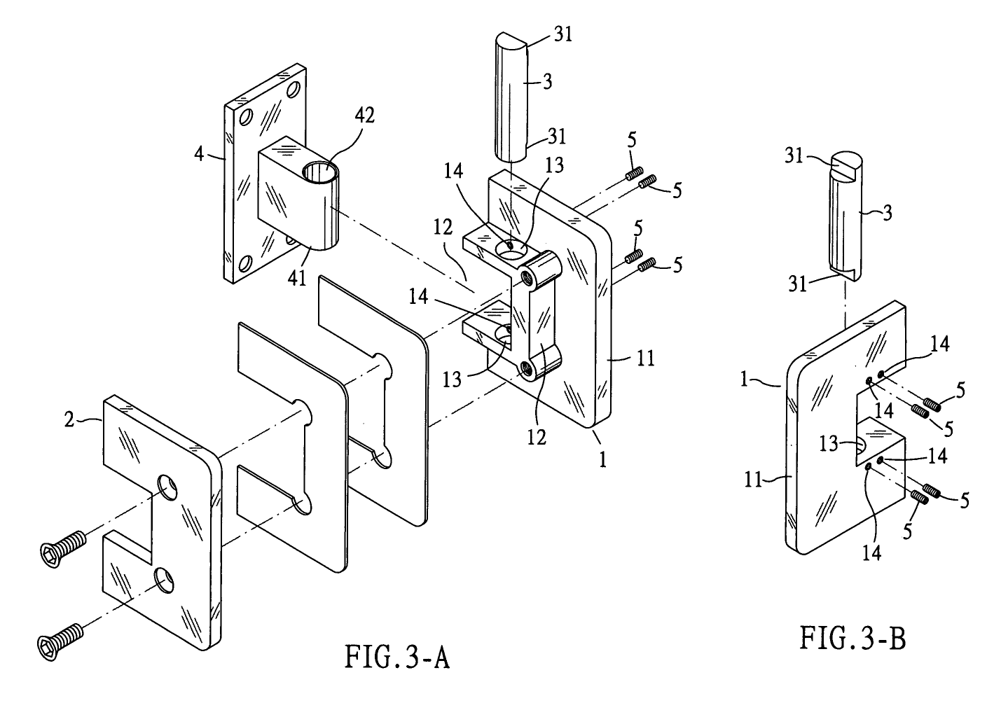

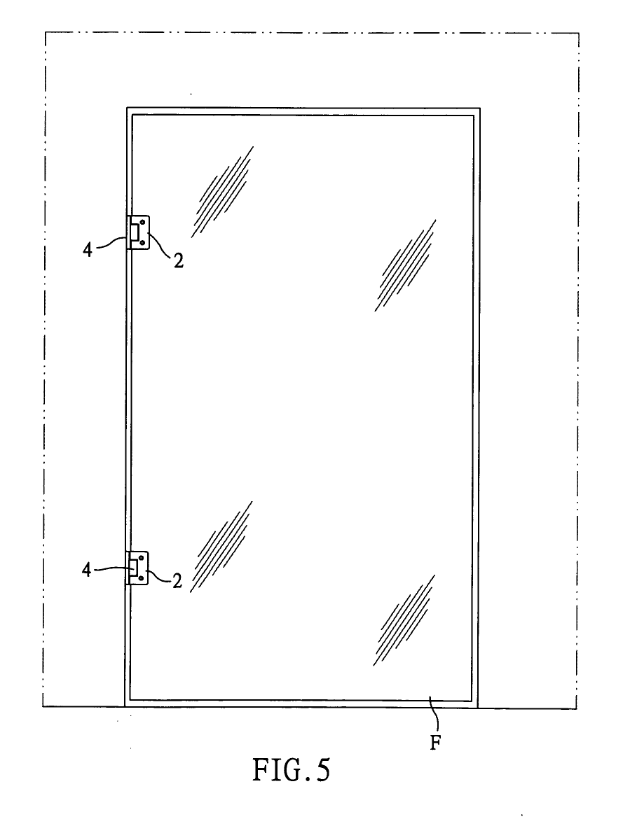

Referring to FIGS. 3A and 3B for a glass door hinge structure of the present invention, the glass door hinge structure is installed at upper and lower positions of a lateral side of a glass door F, such that the glass door F is combined with the hinge body 1, hinge cover 2, axial bolt 3 and fixing base 4 and the fixing base 4 is fixed onto an edge of a doorway as shown in FIG. 5. The hinge body 1 is a thickened face portion 11, and the hinge cover 2 has a protrusion 12 attached onto the internal surface of the protrusion 12, and the protrusion 12 has an indent 121, and a penetrating hole 13 is disposed separately on both sides of the indent 121 for installing the axial bolt 3. Further, upper and lower positions of the thickened face portion 11 have two parallel transversal screw thread holes 14, so that the screw thread hole 14 can be penetrated through an inner edge of the penetrating hole 13 for an interconnection. Further, upper and lower positions on the same side of the axial bolt 3 have a right-angled concavely cut plane 31 and the fixing base 4 at the vertical through hole 42 is protruded from the protrusion 41.

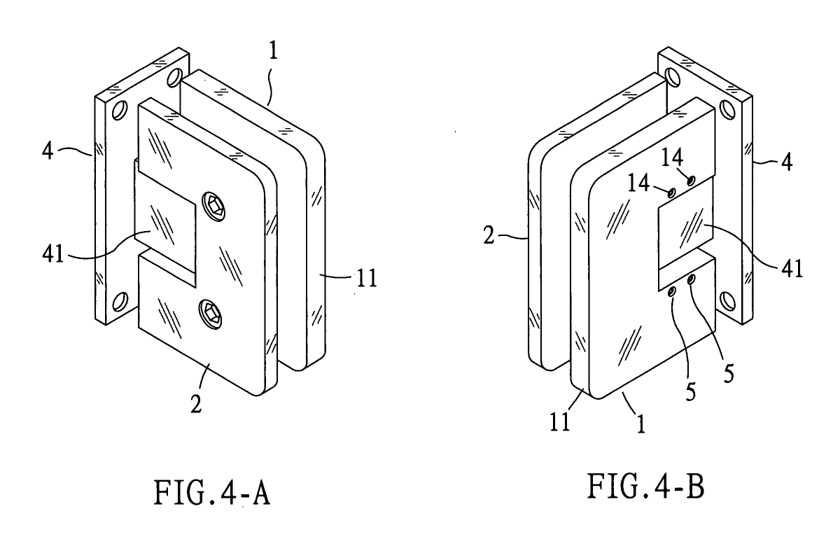

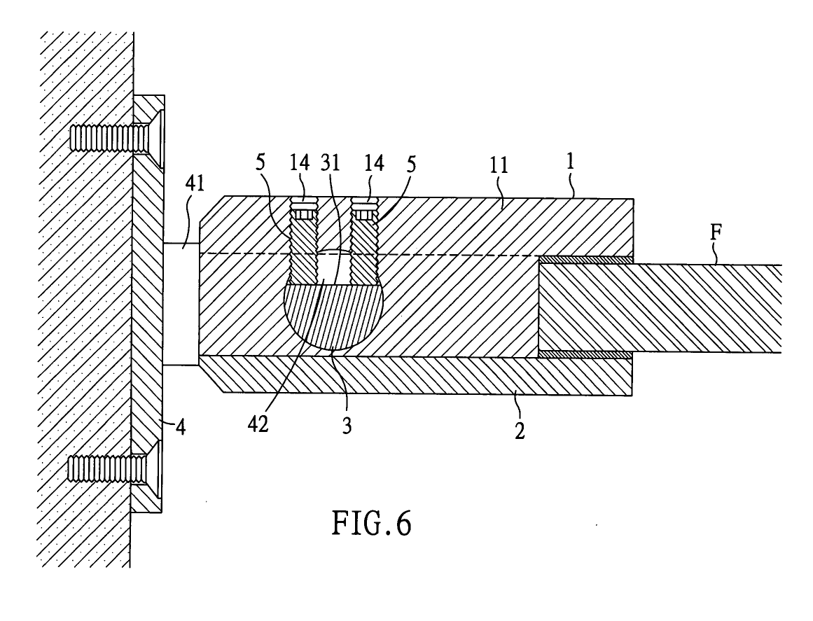

The indent 121 on the protrusion 12 of the hinge body 1 is embedded with the protrusion 41 in the fixing base 4, so that the through hole 42 of the protrusion 41 in the fixing base 4 is aligned precisely with the two penetrating holes 13 of the protrusion 12 of the hinge body 1, and the axial bolt 3 is passed through the through hole 42 and the penetrating hole 13, and the long screw bolt 5 outside the hinge body 1 is screwed into the screw thread hole 14 all the way to a contact limit position on the of the axial bolt 3 of the penetrating hole 13 as shown in FIGS. 4A and 4B. Finally, the glass door F and the hinge cover 2 are installed, and the fixing base 4 is fixed onto the edge of a doorway as shown in FIGS. 5 and 6. Since the installed glass door F is not always aligned evenly with the doorway, the long screw bolt 5 can be turned inward or outward to adjust the angle of the axial bolt 3 to drive the glass door F, the hinge body 1 and the hinge cover 2 to turn slightly and accordingly, so as to align the glass door F evenly with the doorway.

Since the hinge body 1 screwed including a long screw bolt 5 is a thickened face portion 11 for making two parallel transversal screw thread holes 14, therefore the length of the screw thread can be increased. Further, the long screw bolt 5 is screwed into the screw thread hole 14 and up to the concavely cut plane 31 of the axial bolt 3 of the penetrating hole 13, and the whole distal surface of the long screw bolt 5 can be attached completely onto the concavely cut plane 31 of the axial bolt 3 as shown in FIG. 6, and thus enhancing the screw connection and application of the long screw bolt and preventing the glass door hinge structure from being damaged easily.

In summation of the above description, the present invention definitely achieves the expected objective and provides an improved structure to enhance the performance over the prior art. The invention further complies with the patent application requirements and is duly filed for the patent application.

What is claimed is:

1. A glass door hinge structure, installed at upper and lower positions on a lateral side of a glass door for combining said glass door with a hinge body, a hinge cover, an axial bolt and fixing base, and said fixing base being fixed on an edge of a doorway, wherein said hinge body has a protrusion attached onto an inner surface of said hinge cover, and said protrusion is substantially in the shape of an indent, and both sides of said indent respectively have a penetrating hole for installing an axial bolt, such that when said axial bolt is passed through said hinge body and said fixing base, a long screw bolt outside said hinge body is screwed into a screw thread hole and up to a contact limit position on a concavely cut plane of axial bolt of said penetrating hole, and finally said glass door and said hinge cover are installed; characterized in that: upper and lower positions of said thickened protrusion of said hinge body respectively have two parallel and transversal screw thread holes, so that said screw thread hole is penetrated with the inner edge of said penetrating hole, and upper and lower positions of the same side of said axial bolt have a right-angled concavely cut plane; thereby said long screw bolt is turned to adjust the angle of said glass door and align said glass door evenly with said doorway, and said hinge body screwed with said long screw bolt is designed as a thickened face portion for increasing the length of a screw thread of said screw thread hole, and the whole distal surface of said long screw bolt is attached completely onto said concavely cut plane of said axial bolt, so as to enhance the screw connection and application of said long screw bolt and prevent said glass door hinge structure from being damaged.
